(19) United States
(12) Patent Application Publication
(10) Pub. No.: US 2017/0003771 A1
(43) Pub. Date: Jan. 5, 2017

(54) COMPOSITE PUSH-BUTTON CIRCUIT SUPPORTING BOTH PREVIOUS PAGE AND HOMEPAGE FUNCTIONS

(71) Applicant: CHYNG HONG ELECTRONIC CO., LTD., TAICHUNG CITY (TW)

(72) Inventor: Mu-Chun Lin, TAICHUNG (TW)

(21) Appl. No.: 14/790,856

(22) Filed: Jul. 2, 2015

(51) Int. Cl. G06F 3/041; G06F 3/0484

(52) U.S. Cl. CPC G06F 3/041; G06F 3/04847

(57) ABSTRACT

A composite push-button circuit supporting both PREVIOUS PAGE and HOMEPAGE functions includes a push button that is connected with a processor. The processor has a timer and is connected with a first function-controlling module and a second function-controlling module separately. When the processor determines that a duration where the push button remains pressed reaches a predetermined duration, the processor makes the first function-controlling module performs the HOMEPAGE function. When the processor determines that the duration where the push button remains pressed does not reach the predetermined duration, the processor makes the second function-controlling module performs the PREVIOUS PAGE function. Thereby, a user interface equipped with the composite push-button circuit can use a single button to support both the PREVIOUS PAGE and HOMEPAGE functions, thereby making operation more conveniently and efficiently.

### BACKGROUND OF THE INVENTION

1. Technical Field

The present invention relates to a composite push-button circuits, and more particularly to a composite push-button circuit supporting both PREVIOUS PAGE and HOMEPAGE functions.

2. Description of Related Art

In various conventional user interface devices, there are usually both a BACK button for making the screen go back to the previous page and a HOME button for making the screen go back to the homepage (initial screen). When the BACK button is pressed, the user interface goes back to the previous operational stage, and when the HOME button is pressed, the user interface returns to its initial screen.

However, the provision of both the BACK button and the HOME button increases the number of push buttons in the user interface. When operating the user interface, a user has to take time to choose the right button that corresponds to the function he/she wants to activate, and this makes the operation inconvenient. In view of this, the inventor of the present invention proposes the present invention for improving the conventional user interface.

### SUMMARY OF THE INVENTION

The primary objective of the present invention is to provide a composite push-button circuit supporting both PREVIOUS PAGE and HOMEPAGE functions. The composite push-button circuit integrates the PREVIOUS PAGE and HOMEPAGE functions as operated by separate BACK and HOME buttons in the conventional user interface, so as to reduce the number of push buttons required in the user interface. As a result, a user can use a single button activate both of the functions without taking time to choose different buttons for different functions, thereby making operation more conveniently and efficiently.

For achieving the foregoing objective, the discloses composite push-button circuit supporting both PREVIOUS PAGE and HOMEPAGE functions comprises: a push button; a processor, being electrically connected with the push button and having a timer that times a duration where the push button remains pressed and determines whether the duration reaches a predetermined duration, wherein when the timer determines that the duration reaches the predetermined duration, the processor outputs a first executable command, and when the timer determines that the duration does not reach the predetermined duration, the processor outputs a second executable command; a first function-controlling module, being electrically connected with the processor so as to receive and execute the first executable command of the processor; and a second function-controlling module, being electrically connected with the processor so as to receive and execute the second executable command of the processor.

The discloses composite push-button circuit uses the timer to determine whether the duration where the push button remains pressed reaches the predetermined duration. When the timer determines that the duration reaches the predetermined duration, the processor outputs the first executable command, so the first function-controlling module executes the HOMEPAGE function that makes the user interface returns to its initial stage. When the timer determines that the duration does not reach the predetermined duration, the processor outputs the second executable command, so the second function-controlling module executes the PREVIOUS PAGE function that makes the user interface return to the previous operational stage. The composite push-button circuit integrates the PREVIOUS PAGE and HOMEPAGE functions as operated by separate BACK and HOME buttons in the conventional user interface, so as to reduce the number of push buttons required in the user interface. As a result, a user can use a single button activate both of the functions without taking time to choose different buttons for different functions, thereby making operation more conveniently and efficiently.

### BRIEF DESCRIPTION OF THE DRAWINGS

FIG. 1 is a block diagram of the present invention.

FIG. 2 is an applied view of the present invention.

### DETAILED DESCRIPTION OF THE INVENTION

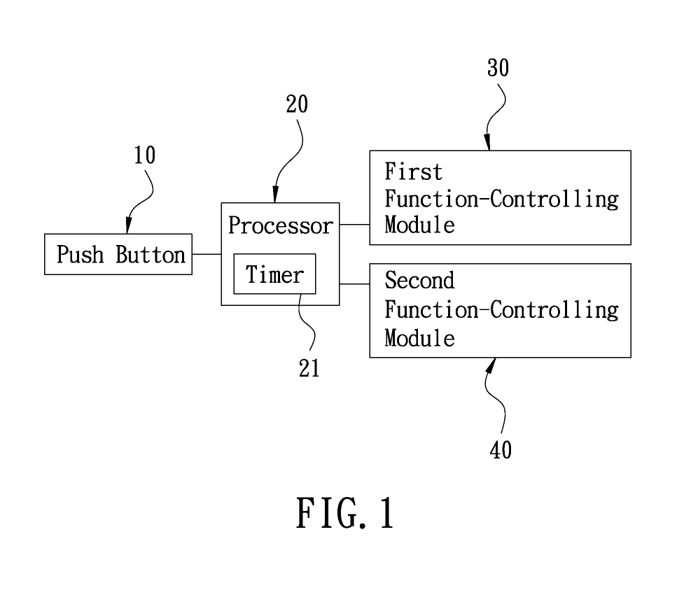

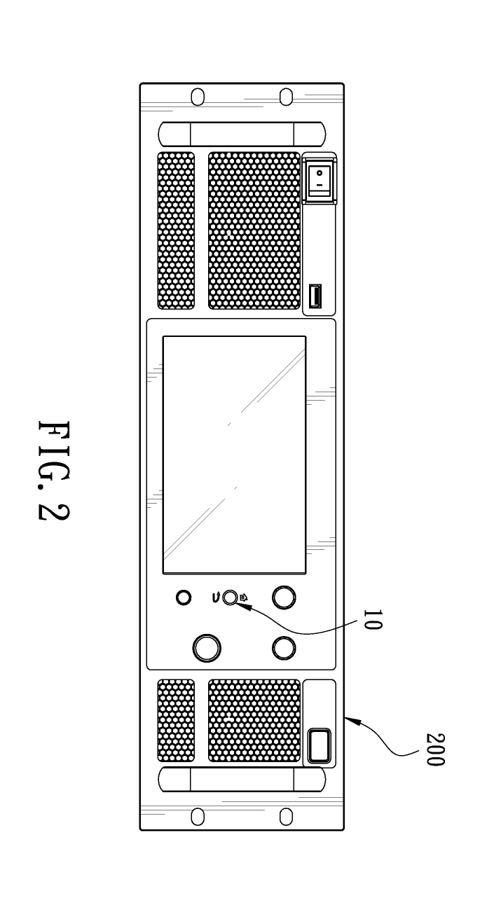

FIG. 1 is a block diagram of the present invention and FIG. 2 is an applied view of the present invention. As shown, according to the present invention, a composite push-button circuit supporting both PREVIOUS PAGE and HOMEPAGE functions comprises a push button 10, a processor 20, a first function-controlling module 30, and a second function-controlling module 40.

The push button 10 may be a physical push button provided in an operation panel 200. However, in other embodiments where the operation panel 200 is in the form of a touch screen, the push button 10 may alternatively be a virtual push button displayed in the touch panel for touch control.

The processor 20 is electrically connected with the push button 10, and has an arithmetic logic function fir executing the commands input from the push button 10. The processor 20 includes a timer 21. The timer 21 times a duration where the push button 10 remains pressed, and determines whether the duration reaches a predetermined duration or not. In the present embodiment, the predetermined duration is set as long as 0.5 second. When the timer 21 determines that the duration where the push button 10 remains pressed reaches the predetermined duration, the processor 20 outputs a first executable command. When the timer 21 determines that the push button 10 the duration where the push button 10 remains pressed does not reach the predetermined duration, the processor 20 outputs a second executable command.

The first function-controlling module 30 is electrically connected with the processor 20, so as to receive and execute the first executable command of the processor 20. In the present embodiment, upon receiving the first executable command of the processor 20, the first function-controlling module 30 executes the HOMEPAGE function that makes the user interface return to its initial stage.

The second function-controlling module 40 is electrically connected with the processor 20, so as to receive and execute the second executable command of the processor 20. In the present embodiment, upon receiving the second executable command of the processor 20, the second function-controlling module 40 executes the PREVIOUS PAGE c function that makes the user interface return to its previous operational stage.

Referring to FIG. 2 together with FIG. 1, when the push button 10 is presses, the timer 21 starts to time the duration where the push button 10 remains pressed, and then determines whether the duration reaches the predetermined duration of 0.5 sec. If the push button 10 has been pressed for more than 0.5 sec., the timer 21 determines that the duration where the push button 10 remains pressed reaches the predetermined duration, so the processor 20 outputs the first executable command, and the first function-controlling module 30 executes the HOMEPAGE function that makes the user interface return to its homepage. On the contrary, when the push button 10 is pressed for less than 0.5 sec., the timer 21 determines that the push button 10 the duration where the push button 10 remains pressed does not reach the predetermined duration, so the processor 20 outputs the second executable command, and the second function-controlling module 40 executes the PREVIOUS PAGE function that makes the user interface return to its previous operational stage. The composite push-button circuit thereby integrates the PREVIOUS PAGE and HOMEPAGE functions as operated by separate BACK and HOME buttons in the conventional user interface, so as to reduce the number of push buttons required in the user interface. As a result, a user can use a single button activate both of the functions without taking time to choose different buttons for different functions, thereby making operation more conveniently and efficiently.

At last, the features and expected effects of the present invention are summarized as blow.

The disclosed composite push-button circuit supporting both PREVIOUS PAGE and HOMEPAGE functions uses the processor 20 to determine whether the push button 10 has been pressed for longer than the predetermined duration. When the processor 20 determines that the push button 10 has been pressed for longer than the predetermined duration, the processor 20 makes the first function-controlling module 30 execute the HOMEPAGE function that makes the user interface return to its initial stage. When the processor 20 determines the push button 10 determines that the push button 10 has been pressed for a duration equal to the predetermined duration, the processor 20 makes the second function-controlling module 40 execute the PREVIOUS PAGE function that makes the user interface return to its previous operational stage. The composite push-button circuit thereby integrates the PREVIOUS PAGE and HOMEPAGE functions as operated by separate BACK and HOME buttons in the conventional user interface, so as to reduce the number of push buttons required in the user interface. As a result, a user can use a single button activate both of the functions without taking time to choose different buttons for different functions, thereby making operation more conveniently and efficiently.

What is claimed is:

1. A composite push-button circuit supporting both PREVIOUS PAGE and HOMEPAGE functions, the composite push-button circuit comprising:
a push button;
a processor, being electrically connected with the push button and having a timer that times a duration where the push button remains pressed and determines whether the duration reaches a predetermined duration, wherein when the timer determines that the duration reaches the predetermined duration, the processor outputs a first executable command, and when the timer determines that the duration does not reach the predetermined duration, the processor outputs a second executable command;
a first function-controlling module, being electrically connected with the processor so as to receive and execute the first executable command of the processor, wherein upon receiving the first executable command of the processor, the first function-controlling module performs the HOMEPAGE function that makes a user interface return to an initial stage of the user interface; and
a second function-controlling module, being electrically connected with the processor so as to receive and execute the second executable command of the processor, wherein upon receiving the second executable command of the processor, the second function-controlling module performs a PREVIOUS PAGE function that makes the user interface return to a previous operational stage.

2. The composite push-button circuit of claim 1, wherein the predetermined duration is set as long as 0.5 second.

3. The composite push-button circuit of claim 1, wherein the push button is a physical push button or a virtual push button for touch control.
